(19) United States
(12) Patent Application Publication
(10) Pub. No.: US 2018/0186471 A1
(43) Pub. Date: Jul. 5, 2018

(54) 360 Degree Camera Mount for Drones and Robots

(71) Applicant: QUALCOMM Incorporated, San Diego, CA (US)

(72) Inventors: Donald Hutson, San Diego, CA (US); Gwendolyn Denise Barriac, Encinitas, CA (US); Paul Ferrell, San Diego, CA (US)

(21) Appl. No.: 15/463,262

(22) Filed: Mar. 20, 2017

Related U.S. Application Data
(60) Provisional application No. 62/441,678, filed on Jan. 3, 2017.

(51) Int. Cl. B64D 47/08; B64C 39/02; G03B 15/00; G03B 17/56; F16M 13/02; G03B 37/00; H04N 5/232; G03B 17/55

(52) U.S. Cl. CPC B64D 47/08; B64C 39/024; G03B 15/006; G03B 17/561; F16M 13/02; B64C 2201/108; H04N 5/23238; G03B 17/55; B64C 2201/127; B64C 2201/027; G03B 37/00

(57) ABSTRACT

An apparatus for mounting cameras to a drone may include a frame having camera mounts for mounting two 190-degree field-of-view cameras in a back-to-back orientation. Positioning two 190-degree field-of-view cameras in a back-to-back orientation enables obtaining 360-degree field-of-view by stitching images from the two cameras together. The frame may be configured to position the cameras at a 30-40-degree tilt angle (e.g., 35°) with respect to a main axis of the drone to enable the respective images to be stitched together with reduced stitch lines while allowing the lower-facing camera to be used for viewing the ground. In some embodiments, the camera apparatus may be mounted to a drone dampening system.

### RELATED APPLICATIONS

This application claims the benefit of priority to U.S. Provisional Application No. 62/441,678 entitled “360 Degree Camera Mount for Drones and Robots” filed Jan. 3, 2017, the entire contents of which are incorporated herein by reference.

### BACKGROUND

Unmanned vehicles are becoming widely adopted in a number of military and commercial applications. Unmanned vehicles can be remotely controlled, autonomous, or semi-autonomous. Unmanned vehicles are typically configured with sensors to obtain information regarding their environment to enable navigation, either on their own or based on commands from a remote operator. Examples of unmanned vehicles include airborne vehicles, terrestrial vehicles, space-based vehicles, or aquatic vehicles.

With the increased use of unmanned aerial vehicles, also referred to as “drones,” unmanned vehicles are now created in many different shapes and sizes. Unmanned aerial vehicles, or drones, are now commonly used for delivery, surveying, photography, and/or power or communications repeater functions. Cameras are an essential component of such drones, as images are used for navigation, collision avoidance and attitude control in addition to payload applications. A common problem is that drone-mounted cameras experience vibrations from propellers and sudden accelerations during maneuvers, which can result in blurred images.

### SUMMARY

Various embodiments include a camera apparatus suitable for use with an unmanned aerial vehicle or drone. In various embodiments, the camera apparatus may include two or more cameras and a frame having one or more camera mounts configured to attach the two or more cameras in a back-to-back configuration, an attachment fixture configured to attach the frame to the drone on a leading edge of the drone, and a tilt mechanism coupled to the attachment fixture and configured to adjust a tilt angle of the one or more camera mounts. In some embodiments, the attachment fixture may include two or more attachment fixtures configured to be fixed to the drone on different portions of a drone dampening system. In some embodiments, the camera apparatus may further include a distal portion of the frame configured to protect a lens of at least one of the two or more cameras.

In some embodiments, the two or more cameras may be 190-degree field-of-view cameras. In such embodiments, the one or more camera mounts may be arranged to enable stitching of images from the two or more cameras to generate a 360-degree field of view combined image. In such embodiments, the tilt angle and the arrangement of the one or more camera mounts may hide the drone from fields of view of the two or more cameras.

In some embodiments, the tilt angle may be at approximately 35 degrees relative to the drone. In some embodiments, the tilt mechanism includes a servomechanism configured to adjust the tilt angle when controlled by a processor of a drone. In some embodiments, the servomechanism may be configured to adjust the tilt angle in response to control signals from a processor of a drone.

In some embodiments, the camera apparatus further includes an inertial measurement unit (IMU) attached to the frame.

In some embodiments, the one or more camera mounts may be configured to provide a gap between the two or more cameras. In some embodiments, the camera apparatus may further a cooling system positioned within the gap between the two or more cameras. In some embodiments, the frame may further include light-emitting diode (LED) mounting locations.

Various embodiments include the frame of the camera apparatus as summarized above. Various embodiments include a drone including a camera apparatus as summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of the various embodiments.

FIG. 1A is a perspective view of a camera apparatus for a drone according to various embodiments.

FIG. 1B is a side elevation view of the camera apparatus in FIG. 1A according to various embodiments.

FIG. 2A is a perspective view of the camera apparatus in FIG. 1A mounted to the drone according to various embodiments.

FIG. 2B is a side elevation view of the camera apparatus mounted to the drone in FIG. 2A according to various embodiments.

FIG. 2C is a perspective view of the camera apparatus in FIG. 1A illustrating a tilt angle of the camera assembly according to some embodiments.

FIG. 3 is a diagram of the camera assembly illustrating how the cameras 110a, 110b provide a 360-degree view according to various embodiments

FIG. 4A is a perspective view of a plurality of camera apparatuses in FIG. 1A mounted to the drone in multiple locations according to various embodiments.

FIG. 4B is a side elevation view of a plurality of camera apparatuses mounted to the drone in FIG. 4A according to various embodiments.

FIG. 5 is a block diagram illustrating components drone suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include a camera apparatus configured to be coupled to an unmanned vehicle. The camera apparatus may include two cameras coupled back-to-back in a camera mount within a frame that includes one or more mounting fixtures for coupling the frame the vehicle. The frame and camera mounts are configured to provide a lightweight and compact configuration for positioning cameras on an unmanned vehicle for navigation and other purposes. When the two cameras each have a 180°-190° field-of-view, images from the two cameras may be stitched together to provide a 360-degree field-of-view. The frame of the camera apparatus may be configured to couple to the unmanned vehicle and orient (e.g., tilt) the cameras in a manner that enables 360-degree field-of-view camera vision with minimized imaging of the vehicle while minimizing the profile of the unmanned vehicle.

As used herein, the terms “unmanned vehicle” refers to various types of remotely controlled, autonomous or semiautonomous vehicles. Autonomous vehicles are capable of sensing their environment and navigating on their own with minimal inputs from a user. Semi-autonomous vehicles may be periodically controlled by an operator. Examples of vehicles suitable for implementing various embodiments include unmanned aerial vehicles (UAVs) or drones, robots, terrestrial vehicles (e.g., autonomous automobiles); space-based vehicles; and aquatic vehicles, including surface or undersea watercraft. While various illustrated and described embodiments refer to a drone (i.e., UAV) application, various embodiments may be equally applicable to other types of unmanned vehicles.

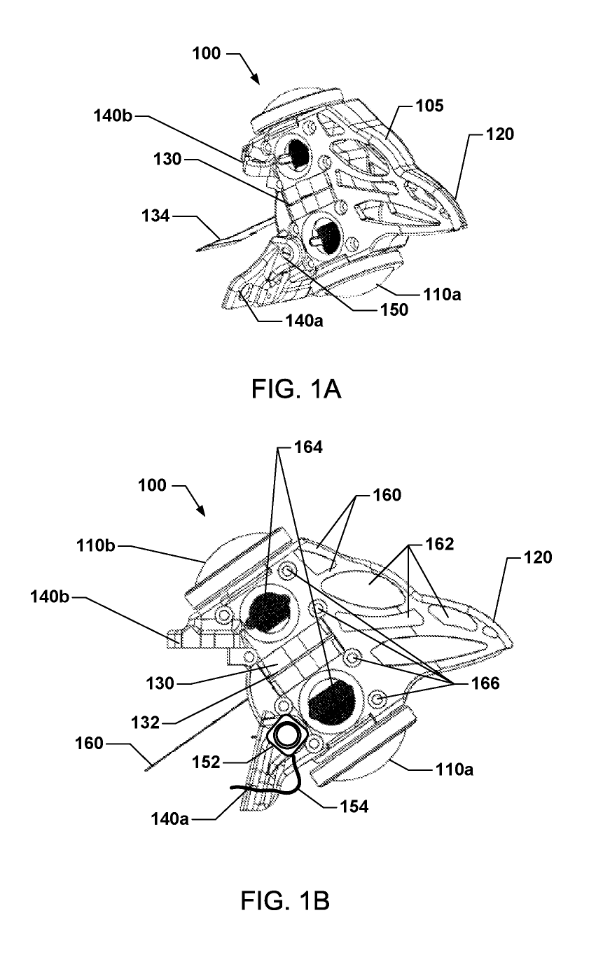

FIGS. 1A-1B show perspective and side views of a camera apparatus 100 according to various embodiments. The camera apparatus 100 may include two cameras 110a, 110b mounted on a frame 105. The camera apparatus 100 may include camera mounts 130, attachment fixtures 140a, 140b, a tilt mechanism 150, and one or more cable connectors 134 mounted on or otherwise supported by the frame 105. The frame 105 may be configured to provide structural support for the cameras 110a, 110b, and provide protection for lenses of the cameras 110a, 110b via the distal portion 120 of the frame 105. The camera mounts 130 may be configured to couple the cameras 110a, 110b to the frame 105 in a back-to-back arrangement. Optionally, the frame 105 may form all or part of a housing of the cameras 110a, 110b. In various embodiments, the camera mounts 130 may include a gap 132 for air cooling or a cooling system between cameras 110a and 110b. In some embodiments, the gap 132 may be sized to enable sufficient air cooling to prevent overheating of the cameras 110a and 110b. In some embodiments, the camera apparatus 100 may include a liquid cooling system (not shown) positioned within the gap 132, with the cooling system configured to prevent overheating of the cameras 110a and 110b.

In some embodiments, the frame 105 may be assembled from a number of components (e.g., wires, struts, etc.) that are glued, welded or otherwise couple together. In some embodiments, the frame 105 may be a unitary construction, such as an injection molded structure or a structure fabricated using additive manufacturing methods. In various embodiments, the frame 105 may be assembled so that open volumes 162 are provided between structural elements 160 in order to reduce the weight while improving the rigidity of the frame 105. In various embodiments, holes 164 may be provided in the frame 105 configured for mounting or attaching more LED lights, such as to increase the visibility of the drone. In some embodiments, at least four additional LED lights may be mounted to the frame. In some embodiments, the holes 164 may also be left empty to provide further air cooling of the cameras 110a and 110b.

In various embodiments, camera fixtures 166 may be used to square the cameras 110a and 110b within the frame 105. Camera fixtures 166 may be bolted, riveted, glued, or otherwise configured to fix the cameras 110a and 110b to the frame 105. Camera fixtures 166 may have a size, shape, and/or orientation that differs from the examples illustrated in the figures. In various embodiments, the number of camera fixtures 166 used to square cameras 110a and 110b may be increased or reduced to facilitate increased strength or enable easy removal and insertion of new/replacement cameras.

For ease of description and illustration, some detailed aspects of the camera apparatus 100 are omitted, such as wiring, frame structure interconnects, or other features that would be known to one of skill in the art. For example, while the camera apparatus 100 is shown and described as having a frame 105 having a number of support members 160 or frame structures, the camera apparatus 100 may be constructed using a molded frame in which support is obtained through the molded structure.

In the example embodiment illustrated in the figures, the camera apparatus 100 includes two attachment fixtures 140a, 140b for coupling the frame 105 to a drone. However, some embodiments may include only one attachment fixture (e.g., 140a) or more than two attachment fixtures, and the attachment fixtures 140a, 140b may have a size, shape, and/or orientation that differs from the examples illustrated in the figures. In some embodiments, the attachment fixtures 140a and 140b may couple the frame 105 to a front leading edge of a drone. In some embodiments, other weighted components of the drone (e.g., a battery compartment) may be positioned on the drone to offset the weight of the camera apparatus 100. Since weight distribution of the drone may affect flight control of the drone, the positioning of the camera apparatus 100 on the drone, and the weight (including weights and components in the camera apparatus 100) may be configuration so that the weight distribution across the drone may be made as evenly distributed as possible.

The tilt mechanism 150 may enable adjustment of the tilt angle of the cameras 110a, 110b with respect to a main axis of the drone. In some embodiments, the tilt mechanism 150 may be a friction pivot for manual adjustment (as shown in FIG. 1A). In some embodiments, the tilt mechanism 150 may include a servomechanism 152 (as shown in FIG. 1B) that may be controlled by a drone processor, such as via a wired control link 154 or a wireless control link (not shown). A servomechanism 152 may enable the tilt angle of the cameras 110a, 110b to be varied during operations, such as to orient the cameras 110a, 110b for navigation during transit to a mission destination, and then reorient the cameras 110a, 110b for ground imagery or surveillance upon arrival at the mission destination.

The tilt angle of the camera apparatus 100 afforded by the tilt mechanism 150 may affect the visible profile of the camera apparatus 100 when mounted to a drone. The tilt angle of the camera apparatus 100 may be adjusted or otherwise selected via the tilt mechanism 150 so that the two cameras 110a, 110b have a minimum view of parts of the drone. For example, by orienting the camera apparatus 100 with a tilt angle of approximately 35° with respect to the main axis plane of the drone, the drone rotors and/or drone body will appear at the edge of the field-of-view of the two cameras 110a, 110b, and thus within the stitch zone of an assembled 360-degree image. The tilt angle may also be adjusted to minimize the profile of the camera apparatus 100 in the direction of travel of the drone. The tilt angle may also be adjusted to support computer vision of the drone used for localization and autonomous navigation. The tilt angle may also be adjusted to minimize the profile of the drone. For example, various components (e.g., rotors) of the drone may be covered by the camera apparatus 100 in a side view.

The one or more cable connectors 134 may any suitable cable connection from the cameras 110a, 110b to the drone. Although common cable connectors may be used (e.g., universal serial bus (USB)-type connectors), in some embodiments the cable connectors may be a higher data rate cable and/or connector (e.g., a high-definition multimedia interface (HDMI) cable/connector) to facilitate relay of high definition video from the cameras to the drone control unit. In various embodiments, the one or more cable connectors 134 may be configured to be easily removable from the drone to prevent damage to the cable connectors 134, such in the event that the frame 105 is inadvertently disconnect from the drone. In some embodiments, the one or more cable connectors 134 may be longer than necessary to allow more slack to avoid damage in the event of an inadvertent disconnection of the camera apparatus 100 from the drone 200.

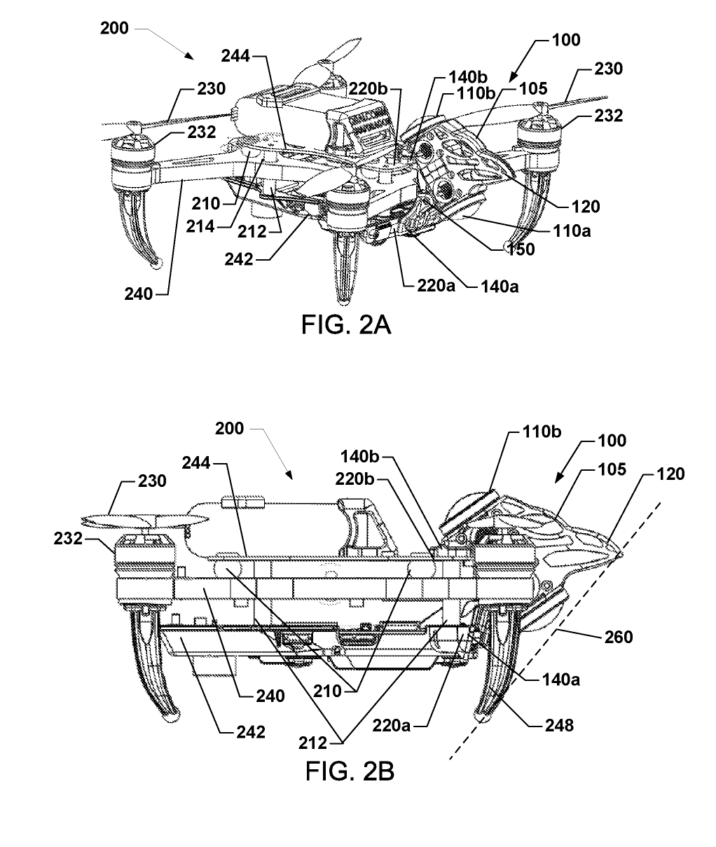

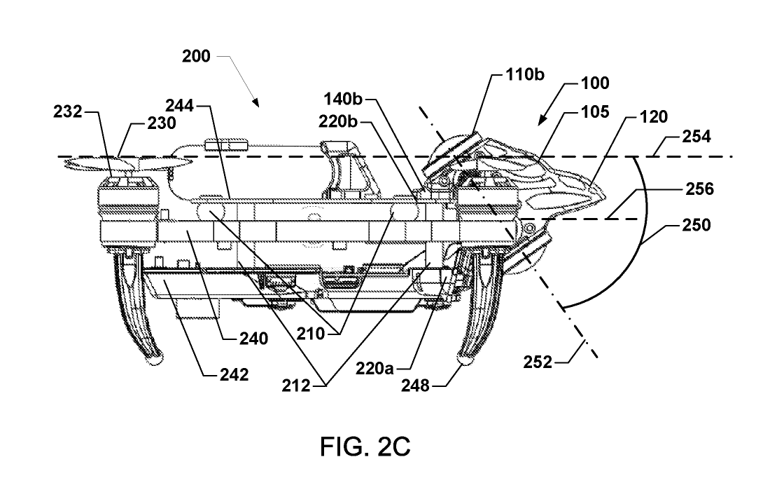

FIGS. 2A and 2B are perspective and side views, respectively, of the camera apparatus 100 mounted to a drone 200. With reference to FIGS. 1A-2B, the attachment fixtures 140a, 140b of the frame 105 may be bolted, riveted, glued, or otherwise affixed to the drone 200 at one or more brackets or similar mounting points 220a, 220b. In some embodiments, the attachment fixtures 140a, 140b may be connected to mounting points 220a, 220b directly on the body of the drone 200. In various embodiments, the attachment fixtures 140a and 140b couple the frame 105 to the drone 200 in different mounting points 220a and 220b based on different drone parameters (e.g., size, shape, etc.) of the drone 200. In some embodiments, the frame 105 may be large enough to hide the front edge drone rotors 230 in a side view.

In some embodiments, the attachment fixtures 140a, 140b may be coupled to mounting points 220a, 220b on the drone 200 that are isolated from vibrations cause by the rotors 230 via a dampening system. In the illustrated example, the dampening system of the drone 200 involves mounting the rotors 230 and drive motors 232 on a middle frame 240 that is isolated from a lower frame 242 (which may include a flight control system) and an upper frame 244 (which may include a battery) by rubber pads 210 and columns 212 that couple the lower frame 242 to the upper frame 244. The middle frame 240 includes holes 214 through which the columns 212 pass, enabling the middle frame 240 to move independent of the lower frame 242 and the upper frame 244. The rubber pads 210 hold the middle frame 240 between the lower frame 242 and the upper frame 244 while minimizing the amount of vibration from the rotors 230 that is transferred from the middle frame 240 to the lower frame 242 and upper frame 244. In the illustrated example, one attachment fixture 140a of the frame 105 is connected to an attachment point 220a on the lower frame 242 and another attachment fixture 140b of the frame 105 is connected to an attachment point 220b on the upper frame 244 of the drone 200. Other forms of damper systems may be used for coupling the frame 105 of the camera assembly 100 to the drone 200, including isolation structures that isolation only the camera assembly from vibrations of the drone 200.

The tilt mechanism 150 on the frame 105 of the camera assembly 100 may include the servomechanism 152 configured to adjust (or otherwise select) and maintain the tilt angle of the frame 105 and cameras 110a, 110b positioned thereon. The servomechanism 152 may be controlled by a processor of the drone 200 until the tilt angle indicated by the servomechanism 152 achieves a desired tilt angle of the frame 105. In general, the frame 105 may pivot about a center of the tilt mechanism 150. In some embodiments, the field-of-view of the cameras 110a, 110b may determine the tilt angle of the frame 105. In some embodiments, the tilt angle may be determined so that the lens for a forward or downward facing camera 110a is protected from collision with the ground or an object by the distal portion 120 of the frame 105 in combination with the drone landing legs 248 of the drone 200. For example, line 260 delineates the volume or buffer space created by the distal portion 120 of the frame 105 and the drone landing legs 248 of the drone 200 protecting the forward or downward facing cameras 110a from large objects or the ground with which the drone 200 might collide.

In some embodiments, the two cameras 110a, 110b may have at least a 180-degree field-of-view so that images can be stitched together to generate a 360-degree field-of-view about the drone 200. In some embodiments, the cameras 110a, 110b may be selected based on weight, size, field-of-view, and/or image quality to minimize effects on movement of the drone 200.

FIG. 2C illustrates the tilt angle of the camera apparatus 100 according to various embodiments. With reference to FIGS. 1A-2C, the camera apparatus 100 may be attached the drone 200 with a tilt angle 250 of the centerline 252 of the cameras 110a, 110b with respect to a main axis plane 254 or 256 of the drone. In some embodiments, the main axis plane 254 may be the horizontal plane of the rotors 230. Alternatively, the main axis plane 256 may be a plane through a central portion of the drone 200 in which approximately half of the volume of the drone is above the plane 256 and approximately half the volume of the drone is below the plane 256. As illustrated, the horizontal plane of the rotors 230 may be parallel to the plane through the central portion of the drone 200.

In some embodiments, the tilt angle 250 may be between approximately 30 degrees and approximately 40 degrees relative to the main axis plane 254, 256 of the drone (e.g., the plane 254 of the rotors). In some embodiments, the tilt angle 250 may be set to approximately 35 degrees relative to the main axis plane 254, 256 of the drone 200. A tilt angle of about 35 degrees relative to the main axis plane 254, 256 may minimize the profile of the drone, as well as provide a largely unobstructed 360-degree field of vision when images of both cameras 110a, 110b are stitched together. In various embodiments, the tilt angle 250 may be adjusted so that a combination with the distal portion 120 of the frame 105 and the drone landing legs 248 provide protection for the forward or downward facing camera 110a lens from impact with the ground or objects, thereby creating a buffer volume when crash landing to limit damage to the lens of the camera 110a.

As described, the tilt angle 250 may be adjusted via a tilt mechanism 150 before flight or dynamically during flight. In some embodiments, the tilt angle 250 may be indexed for various mission requirements or operational parameters. Examples of various mission parameters may include visibility of the drone 200 (i.e., profile minimization), lighting, vision capabilities of the cameras 110a, 110b, weight distribution of the drone 200, and drone component/camera protection. The indexed tilt angles may include ranges of effective angles based on drone parameters (e.g., size, shape, etc.).

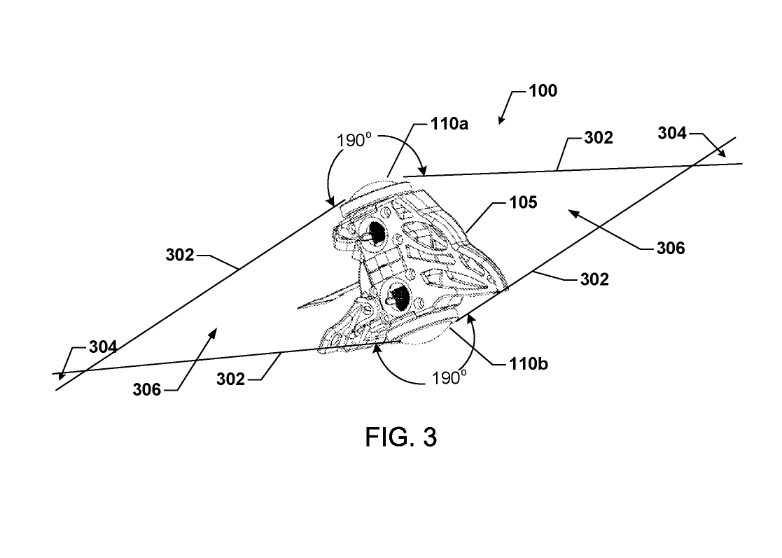

FIG. 3 is a diagram of the camera apparatus 100 illustrating how the cameras 110a, 110b provide a 360-degree view. With reference to FIGS. 1A-3, the cameras 110a, 110b may be two 190-degree field-of-view cameras mounted back to back. In this configuration, the fields of view (indicated by lines 302) of the two cameras 110a, 110b overlap 304. This enables the images from the cameras 110a, 110b to be stitched together electronically in real-time to generate a 360-degree view image for control of the drone (e.g., 200). In some embodiments, the 360-degree field-of-view may be generated through real-time stitching of the images/data taken from each of the 190-degree field-of-view cameras. The cameras 110a, 110b may be placed close together in a back-to-back orientation on the frame 105 of the camera assembly 100 so that stitching of the images is minimized. In this configuration, a volume 306 may be present between the fields of view of the cameras 110a, 110b that will not appear in a stitched together 360-degree image. By controlling the tilt angle 250 of the camera assembly 100, such as to about 35 degrees with respect to the main axis plane 254, 256 of the drone (e.g., 200), and the separation of the lenses of the two cameras 110a, 110b, much (if not all) of the drone may not appear in such a stitched together image. In some embodiments, more than two cameras 110a, 110b may be used to generate the 360-degree field-of-view.

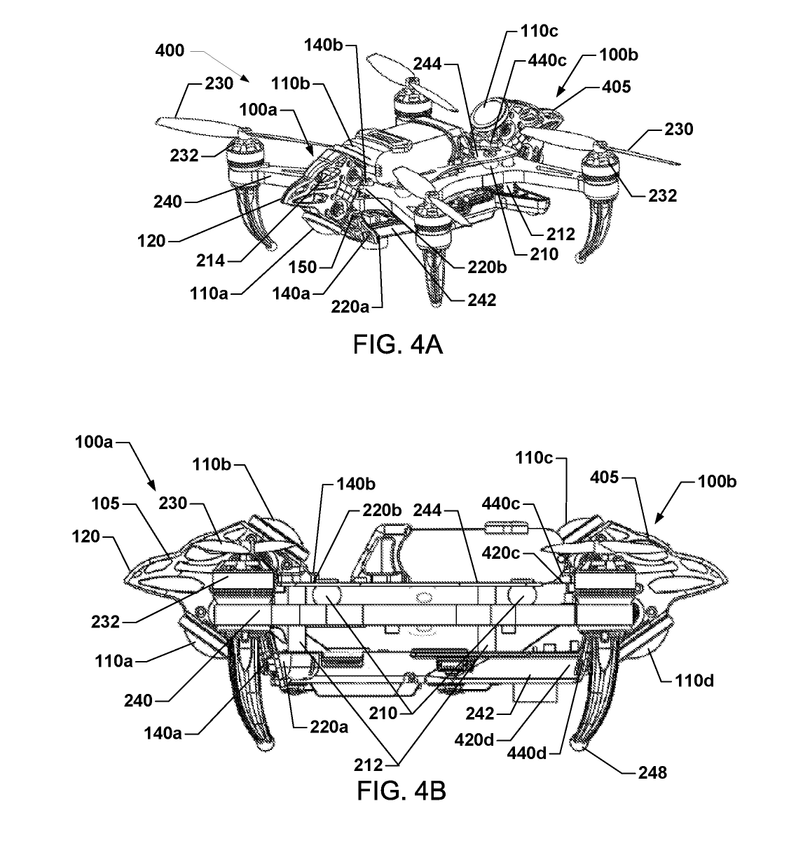

FIGS. 4A and 4B are perspective and side views, respectively, of a plurality of camera apparatuses 100a and 100b mounted to a drone 400. With reference to FIGS. 1A-4B, the attachment fixtures 140a, 140b, 440c, 440d of the frames 105, 405 may be bolted, riveted, glued, or otherwise affixed to the drone 400 at one or more brackets or similar mounting points 220a, 220b, 420c, 420d. In some embodiments, the attachment fixtures 140a, 140b, 440c, 440d may be connected to mounting points 220a, 220b, 420c, 420d directly on the body of the drone 400. In various embodiments, the camera apparatuses 100a and 100b may be mounted to the drone 400 on the front edge and the back edge of the drone respectively.

In some embodiments, the camera apparatus 100b may be similar to or the same as the camera apparatus 100a. The camera apparatuses 100a and 100b may include cameras 110a, 110b, 110c, 110d that have wide (e.g.,) 180°-190° fields of view and that are positioned so that the drone rotors 230 may not appear within the camera images. In some embodiments, weighted components (e.g., a battery compartment) of the drone 400 may be positioned to provide counter weights for the camera apparatuses 100a and 100b, and vice versa, so that component weights may be evenly distributed about the drone 400. In various embodiments, the camera apparatuses 100a and 100b may be different and weighting of the drone 400 may be offset by components of the drone 400.

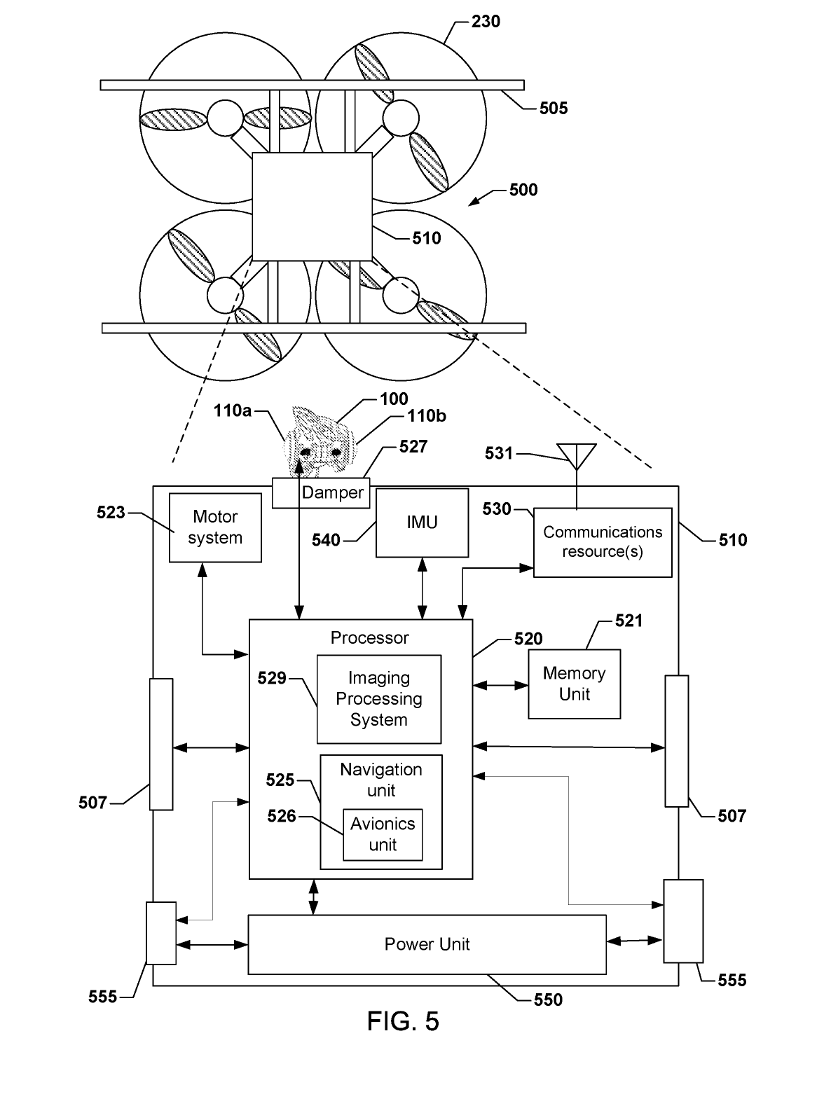

FIG. 5 illustrates components of an example drone 500 for use with various embodiments. With reference to FIGS. 1A-5, the illustrated drone 500 (which may be an example of the drone 200, 400) is a “quadcopter” having four horizontally configured rotary lift propellers, or rotors 230 and motors fixed to a frame 505. The frame 505 may support a control unit 510, landing skids and the propulsion motors, power source (power unit 550) (e.g., battery), payload securing mechanism (payload securing unit 507), and other components. The rotors 230 are driven by corresponding motors (e.g., 232) to provide lift-off (or take-off) as well as other aerial movements (e.g., forward progression, ascension, descending, lateral movements, tilting, rotating, etc.). The drone 500 is illustrated as an example of a drone that may utilize various embodiments, but is not intended to imply or require that various embodiments are limited to rotorcraft drones. Instead, various embodiments may be used with winged drones as well. Further, various embodiments may equally be used with land-based autonomous vehicles, water-borne autonomous vehicles, and space-based autonomous vehicles. A drone may be propelled for flight in any of a number of known ways. For example, a plurality of propulsion units, each including one or more rotors, may provide propulsion or lifting forces for the drone. In addition, the drone may include wheels, tank-treads, or other non-aerial movement mechanisms to enable movement on the ground, on or in water, and combinations thereof. The drone may be powered by one or more types of power source, such as electrical, chemical, electro-chemical, or other power reserve, which may power the propulsion units, the onboard computing device, and/or other onboard components.

The drone 500 may be provided with a control unit 510. The control unit 510 may include a processor 520, one or more communication resources 530, an IMU 540, and a power unit 550. The processor 520 may be coupled to a memory unit 521 and a navigation unit 525. The processor 520 may be configured with processor-executable instructions to control flight and other operations of the drone 500, including operations of various embodiments. In some embodiments, the processor 520 may be coupled to a payload securing unit 507 and landing unit 555. The processor 520 may be powered from the power unit 550, such as a battery.

The processor 520 may be coupled to a motor system 523 that is configured to manage the motors that drive the rotors 230. The motor system 523 may include one or more propeller drivers. Each of the propeller drivers may include a motor (e.g., 232), a motor shaft (not shown), and a propeller or rotor 230.

Through control of the individual motors of the rotors 230, the drone 500 may be controlled in flight. In the processor 520, a navigation unit 525 may collect data and determine the present position and orientation of the drone 500, the appropriate course towards a destination, etc.

The camera apparatus 100 coupled to the drone 500 may provide image data from two (or more) cameras 110a, 110b to an image processing system 529 within or coupled to the processor 520. The image processing system 529 may be a separate image processor, such as an application specific integrated circuit (ASIC) or DSP, configured for processing images, including stitching together images from the two (or more) cameras 110a, 110b to produce 360-degree images. Alternatively, the image processing system 529 may be implemented in software executing within the processor 520. Each of the cameras 110a, 110b may include sub-components other than image or video capturing sensors, including auto-focusing circuitry, International Organization for Standardization (ISO) adjustment circuitry, and shutter speed adjustment circuitry, etc.

The control unit 510 may include one or more communication resources 530, which may be coupled to an antenna 531 and include one or more transceivers. The transceiver(s) may include any of modulators, de-modulators, encoders, decoders, encryption modules, decryption modules, amplifiers, and filters. The communication resource(s) 530 may be capable of device-to-device communication with other drones, wireless communication devices carried by a user (e.g., a smartphone), a drone controller, ground stations such as mobile telephony network base stations, and other devices or electronic systems.

In some embodiments, the communication resource(s) 530 may include a Global Navigation Satellite System (GNSS) receiver (e.g., a Global Position System (GPS) receiver) configured to provide position information to the navigation unit 525. A GNSS receiver may provide three-dimensional coordinate information to the drone 500 by processing signals received from three or more GNSS satellites. In some embodiments, the navigation unit 525 may use an additional or alternate source of positioning signals other than GNSS or GPS. For example, the navigation unit 525 may receive information from processed images obtained by one or more of the cameras 110a, 110b to determine speed and direction of travel and attitude information by processing images of the ground.

An avionics component 526 of the navigation unit 525 may be configured to provide flight control-related information, such as altitude, attitude, airspeed, heading and similar information that may be used for navigation purposes. The avionics component 526 may also provide data regarding the orientation and accelerations of the drone 500 that may be used in navigation calculations.

The navigation unit 525 may include or be coupled to an inertial measurement unit (IMU) 540 configured to supply data to the navigation unit 525 and/or the avionics component 526. For example, the IMU 540 may include inertial sensors, such as one or more accelerometers (providing motion sensing readings), one or more gyroscopes (providing rotation sensing readings), one or more magnetometers (providing direction sensing), or any combination thereof. An IMU 540 may also include barometers, thermometers, audio sensors, motion sensors, etc. The IMU 540 may provide information regarding accelerations and orientation (e.g., with respect to the gravity gradient and earth's magnetic field) to enable the navigation unit 525 to perform navigational calculations, e.g., via dead reckoning, including at least one of the position, orientation (i.e., pitch, roll, and/or yaw), and velocity (e.g., direction and speed of movement) of the drone 500. A barometer may provide ambient pressure readings used to approximate elevation level (e.g., absolute elevation level) of the drone 500.

In some embodiments, the navigation unit 525 may determine position information by tracking land features below and around the drone 500 appearing in camera images (e.g., recognizing a road, landmarks, highway signage, etc.) using a process referred to as visual inertial odometry (VIO). Also, the navigation unit 525 may recognize or react to obstacles imaged or detected by the cameras 110a, 110b. The navigation unit 525 may navigate using a combination of navigation techniques, including dead-reckoning, camera-based recognition of the land features that may be used instead of or in combination with GNSS position information.

As described, the drone 500 may include a damper system 527 to which a camera apparatus 100 may be attached. The damper system 527 may use a variety of structures to reduce the magnitude of vibrations generated by the rotor 230 that are transferred to the camera apparatus 100.

In some embodiments, the IMU 540 may be positioned on the drone 500 close to an attachment point (e.g., 220a, 220B) for the camera apparatus 100. In some embodiments, the IMU 540 may be positioned in the camera apparatus 100 to be closer to the cameras 110a, 110b. Positioning the IMU 540 close to the cameras 110a, 110b may facilitate VIO, localization algorithms, autonomous vision, and/or computer vision because the accelerations and orientations measured by the IMU 540 will more closely match the forces and angles experienced by the cameras. This may facilitate using digital processing of camera image data to track objects in the field of view for VIO, as well as object recognition and collision avoidance.

In some embodiments, the processor 520 may be configured to send control signals to the servomechanism 152 (e.g., via a wired control link 154) to adjust or otherwise select the tilt axis of the camera assembly 100.

The one or more communication resources 530 may be configured to receive signals via the antenna 531 from a ground controller or ground based source of information and provide commands/data to the processor and/or the navigation unit to assist in operation of the drone 500. In some embodiments, commands for adjusting the tilt angle 250 of the frame 105 may be received via the one or more communication resources 530. In some embodiments, the drone 500 may receive signals from wireless communication devices for changing the tilt angle 250 through wireless signals as the drone 500 is in midflight or stationary.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A camera apparatus for a drone, comprising:
two or more cameras; and
a frame comprising:
one or more camera mounts configured to attach the two or more cameras in a back-to-back configuration;
an attachment fixture configured to attach the frame to the drone on a leading edge of the drone; and
a tilt mechanism coupled to the attachment fixture and configured to adjust a tilt angle of the one or more camera mounts.

2. The camera apparatus of claim 1, wherein the attachment fixture comprises two or more attachment fixtures configured to be fixed to the drone on different portions of a drone dampening system.

3. The camera apparatus of claim 1, wherein a distal portion of the frame is configured to protect a lens of at least one of the two or more cameras.

4. The camera apparatus of claim 1, wherein the two or more cameras are 190-degree field-of-view cameras.

5. The camera apparatus of claim 4, wherein the one or more camera mounts are arranged to enable stitching of images from the two or more cameras to generate a 360-degree field of view combined image.

6. The camera apparatus of claim 5, wherein the tilt angle and arrangement of the one or more camera mounts hides the drone from fields of view of the two or more cameras.

7. The camera apparatus of claim 1, wherein the tilt angle is at approximately 35 degrees relative to a main axis of the drone when the camera apparatus is attached to the drone.

8. The camera apparatus of claim 1, wherein the tilt mechanism includes a servomechanism configured to adjust the tilt angle when controlled by a processor of a drone.

9. The camera apparatus of claim 1, further comprising:
an inertial measurement unit (IMU) attached to the frame.

10. The camera apparatus of claim 1, wherein the one or more camera mounts are configured to provide a gap between the two or more cameras.

11. The camera apparatus of claim 10, further comprising a cooling system positioned within the gap between the two or more cameras.

12. The camera apparatus of claim 1, wherein the frame further comprises LED mounting locations.

13. A frame for mounting cameras to a drone, comprising:
one or more camera mounts configured to attach two or more cameras in a back-to-back configuration;
an attachment fixture configured to attach the frame to the drone on a leading edge of the drone; and
a tilt mechanism coupled to the attachment fixture and configured to adjust a tilt angle of the one or more camera mounts.

14. The frame of claim 13, wherein the attachment fixture comprises two or more attachment fixtures configured to be fixed to the drone on different portions of a drone dampening system.

15. The frame of claim 13, wherein a distal portion of the frame is configured to protect a camera coupled to the one or more camera mounts.

16. The frame of claim 13, wherein the one or more camera mounts are configured to provide a gap between the two or more cameras.

17. The frame of claim 16, further comprising a cooling system positioned within the gap between the two or more cameras.

18. A drone, comprising:
a camera apparatus coupled to the drone, the camera apparatus comprising:
two or more cameras; and
a frame comprising:
one or more camera mounts configured to attach the two or more cameras in a back-to-back configuration;
an attachment fixture fixing the frame to the drone on a leading edge of the drone; and
a tilt mechanism coupled to the attachment fixture and configured to adjust a tilt angle of the one or more camera mounts with respect to the drone.

19. The drone of claim 18, further comprising a dampening system, wherein the attachment fixture is configured to attach the frame to the dampening system.

20. The drone of claim 19, wherein the attachment fixture comprises two or more attachment fixtures configured to be fixed to the drone on different portions of the dampening system.

21. The drone of claim 18, wherein a distal portion of the frame is configured to protect a lens of at least one of the two or more cameras.

22. The drone of claim 18, wherein the two or more cameras are 190-degree field-of-view cameras, and wherein the one or more camera mounts are arranged to enable stitching of images from the two or more cameras to generate a 360-degree field of view combined image.

23. The drone of claim 22, wherein the tilt angle and arrangement of the one or more camera mounts hides the drone from fields of view of the two or more cameras.

24. The drone of claim 18, wherein the tilt angle is at approximately 35 degrees relative to a main axis plane of the drone.

25. The drone of claim 18, further comprising a processor, wherein the tilt mechanism includes a servomechanism configured to adjust the tilt angle when controlled by the processor.

26. A method of manufacturing a camera apparatus for a drone, comprising:
providing two or more cameras; and
providing a frame comprising:
mounting the two or more cameras to the frame in a back-to-back configuration;
configuring an attachment fixture to attach the frame to the drone on a leading edge of the drone; and
coupling a tilt mechanism to the attachment fixture, the tilt mechanism configured to adjust a tilt angle of the two or more cameras.
